(19) United States
(12) Patent Application Publication
(10) Pub. No.: US 2008/0109466 A1
(43) Pub. Date: May 8, 2008

(54) Virtual Deletion In Merged Registry keys

(75) Inventors: Jeffrey L. Havens, Issaquah, WA (US); Frederick J. Smith, Redmond, WA (US); Yousef A. Khalidi, Bellevue, WA (US); Madhusudhan Talluri, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/555,731

(22) Filed: Nov. 2, 2006

(51) Int. Cl. G06F 7/00

(52) U.S. Cl. 707/102

(57) ABSTRACT

An element such as a Registry key or value is virtually deleted by creating a deletion marker for the element. Two or more separate sets of physical Registry keys/values are presented as one merged (virtual) Registry to a process running in a silo. The operating system provides the merged view of the Registry by monitoring Registry key or value system requests made by processes in silos on a computer or computer system and filtering out those elements associated with deletion markers. Special processing is invoked in response to detecting certain types of Registry key or value system access requests, including but not limited to: enumeration, open, create, rename or delete.

### BACKGROUND

The Registry is a central hierarchical database used in some operating systems including Microsoft WINDOWS 9x, WINDOWS CE, WINDOWS NT, WINDOWS 2000 and WINDOWS XP. The Registry is used to store information required to configure the system for one or more users, applications and hardware devices. The Registry includes information that WINDOWS continually references during operation, such as profiles for each user, the applications installed on the computer, the types of documents that each application can create, property sheet settings for folders and application icons, what hardware exists on the system, the ports that are being used and so on. At times it may be desirable to present a logical view of a registry key that is made up of two or more physical keys.

It may be also sometimes be desirable to allow different access levels to different parts of the Registry directory. For example, it may be desirable to allow application A to delete a particular Registry key but not to allow application B to delete that Registry key or to allow application A to add its own value for a particular key. Embodiments of the invention address these and other needs.

### SUMMARY

Two or more groups of separate physical Registry keys are presented as a single (virtual) Registry to an application running in a controlled execution environment called a silo. All of the operations normally available to be performed on the keys and key values in the Registry can be performed on the merge Registry, however, the operating system controls the level of access to the keys in the merge Registry. The operating system provides the merged view of the Registry by a Registry filter driver or other kernel-level operating system code. The Registry filter model provides a single callback with a notification code indicating the reason the callback was called. The callback handler may be implemented as a large switch statement with code to handle various notifications. Examples of types of notifications which trigger the special processing include: enumeration of children keys (sub-keys), enumeration of the value of a key, query a key, query a value, set a value on a key, modify security on a key, load a key, close a key, create or open a key, delete a key, delete a value or rename a key.

A need for virtual deletion of a Registry key or value may become necessary or desirable in circumstances including the following:
The user who makes the request to delete the Registry key or value has permission to delete the key or value based on the ACL (access control list) associated with the key/value.
The private contributing location of the merge key has delete permission via its access mask.
Delete semantic support is enabled for the merge key for which the delete request is received.

When all of the above conditions are met, a delete marker is created in the private location for the Registry key or value being virtually deleted. From the silo's point of view, a Registry key or value so marked is deleted. Hence special processing for virtual deletion may be required when certain types of Registry key/value access operations are requested. Examples of types of requests which trigger the special virtual deletion processing include enumeration, open, create, rename, delete key and delete value.

### BRIEF DESCRIPTION OF THE DRAWINGS

In the drawings:

FIG. 1 is a block diagram illustrating an exemplary computing environment in which aspects of the invention may be implemented;

FIG. 2 is a block diagram of a system for merging Registry keys or values in accordance with some embodiments of the invention;

FIG. 3 is a flow diagram of a method for merging Registry keys or values in accordance with some embodiments of the invention;

FIG. 4 is a flow diagram of a portion of the method of FIG. 3 in accordance with some embodiments of the invention;

FIG. 5 is a flow diagram of virtual deletion processing for an open/create request in accordance with some embodiments of the invention;

FIG. 6 is a flow diagram of virtual deletion processing for an enumeration request in accordance with some embodiments of the invention;

FIG. 7 is a flow diagram of virtual deletion processing for a delete request in accordance with some embodiments of the invention; and

FIG. 8 is a flow diagram of virtual deletion processing for a query in accordance with some embodiments of the invention.

### DETAILED DESCRIPTION

### Overview

At times it may be desirable to present a logical view of a registry key that is made up of two or more physical keys. For example, it might be desirable to provide a merge between an existing registry key, and a new empty key. New registry keys and values created by a process would go into the initially empty key, but all the state from the existing registry would be visible to the process. This allows a process to store its “private” changes in a separate key, and not modify a shared “public” portion of the registry. Typically, however, current known operating systems provide all processes with the same view of the Registry keys.

Thus, in many systems, limited points of containment in the system exist at the operating system process level and at the machine boundary of the operating system itself, but in between these levels, security controls such as Access Control Lists (ACLs) and privileges associated with the identity of the user running the application are used to control process access to Registry key or values. Because access to system resources is associated with the identity of the user running the application rather than with the application itself, the application may have access to Registry key or values that the application does not need, as demonstrated by the example above. Because multiple applications may be able to modify the same Registry key or value, incompatibility between applications can result. Security problems may also arise, as one application may maliciously or accidentally interfere with the operation of another application.

An intra-operating system isolation/containment mechanism called herein a silo provides for the grouping and isolation of processes running on a single computer using a single instance of the operating system. A single instance of the operating system divides the processing space for the system into multiple side-by-side and/or nested execution environments (silos) enabling the controlled sharing of some Registry keys and restriction of access to other keys. The operating system controls Registry key sharing and access by creating different views of the Registry for each silo. The view appears to processes running in the silo to be a single directory which is the union of two or more sets of contributing keys. That is, the keys available to an application depend on which silo the application is running in and the Registry that an application running in a silo “sees” is created by apparently merging two or more sets of keys. The single OS image serving the computer or computer system thus provides a different view of the Registry so as to control which process, group of processes, application or group of applications can use which keys and whether the application can read or read and write keys. Access to keys and the degree of access to keys is therefore directly associated with or based on the silo that the process, application, group of processes or group of applications is placed in and is not solely determined by user privileges.

Merge support for the Registry may be implemented via a Registry filter driver or other kernel-level operating system code. The Registry filter model provides in some embodiments a single callback with a notification code indicating the reason the callback was called. The callback handler thus in some embodiments is a large switch statement with code to handle various notifications. Notifications receiving special processing include enumeration of Registry key, enumeration of the value of a Registry key, query information concerning a Registry key, query a value, set a value on a key, modify security on a key, load a key, close key, create key, rename key and delete key or delete value of a key. A create key notification is received when a caller wants to create or open a registry key. The driver examines the name of the key being accessed and determines if special handling is required. If the process issuing the request is not in a silo, no special processing is required. If the process issuing the request is in a silo, the merge key metadata for the silo issuing the request is retrieved. If the key name being accessed is within a merge key, special processing is performed. If the key exists in the private location, (silo-specific Registry keys), the private location is used when forwarding the request. If the key does not exist in the private location, the public location is examined for the key. If the key exists in the public location, (global Registry keys), the public location is used when forwarding the request. If the key does not exist in the public or private location, information is returned so that either an error can be returned (i.e., an error indicating failure to open a key which does not exist) or the key can be created. If the key name being accessed is not within a merge key, no special processing is performed. If special handling was performed, metadata is associated with the key.

If metadata were associated with a request during a create key operation and the request to open the key was successful, the metadata is attached to the key. When a key is closed, any metadata associated with the key is deleted. When a client application tries to enumerate the sub-key values for an open key, a special handler is invoked. Any metadata associated with the key is retrieved. If metadata is found, and the metadata indicates that the key is a merge key, the contents of the list of keys which exist in each of the contributing keys is returned to the caller.

The registry API for querying keys in some embodiments is implemented by passing in an index, and returning the result. For a given index the contents of the contributing keys are considered, what should be returned for that index is determined, and is returned. The current location in each of the contributing directories during the enumeration is tracked, and the appropriate next value is returned each time. That is, all the results from one contributing key are returned. Results for subsequent keys are returned if the same key name has not already been enumerated. If the caller looks at an index below the current index, the internally cached index's are reset and processing is restarted. Sub-keys in a key or values in a key can be enumerated. Sub-keys or values are returned to the caller, as requested. If a request is received requesting the name of a key, the silo relative name rather than the physical name of the key in the registry is returned. Thus if a request to retrieve key information is received, the information is retrieved and the requested information is updated so that it matches the information the caller expects. For example, suppose a name of a key is requested. The name of the key is retrieved and the name that is sent back to the caller is updated so that it matches the name the caller used to open the key—keeping the illusion that all of the contents of the contributing keys are in the same merge key. If a key is being renamed, the new name, or new location is validated based on the “merge” directory view exposed to the application. Thus, if the user wants to move the key to a new location, the new location is updated based on the silo's view of the namespace.

When two or more physical Registry keys are exposed via one logical view, deleting a key or value may expose or unhide a key or value that has the same name as the deleted key/value in one of the other contributing sets of keys. Typically in a merged key scenario, the contributing sets of keys are ranked. When a collision occurs (that is, a value with the same name exists in two or more of the contributing keys), the ranking policy determines which value will be exposed. However, if the highest ranked key has been deleted, the value with the same name from the other (next highest ranking) contributing key will be exposed, absent intervention. Exposure of that key may not be desired. Hence, there is a need to “remember” that a key or value with the same name existed in a contributing key and prevent exposure of that value when a higher ranked key of the same name has been deleted.

Suppose, for example, that the same key appears in both a public portion and a private portion of a merge Registry. Typically, when a merge key is exposed, a private directory, location or portion of the Registry directory is write-enabled while the public portion is read-only. Both portions contribute to a logical key view. New keys and values and potentially modified values (via copy-on-write, for example) are written to the private portion. Thus a value created in a private key will mask a value with the same name in one or more of the public keys. But, if the value in the private key is deleted, one of the public values may be exposed or unhidden. To an application that previously accessed the private Registry key value, the private value will not appear to have been deleted. It will now access the previously hidden but now exposed Registry value instead, which to the application's knowledge, is the same value, although the content of the previously hidden Registry key may well be different. Furthermore, further attempts to delete the Registry value will fail because the value now being opened is in a read-only location. This is problematic.

To address these problems, in accordance with embodiments of the invention, a marker is added in the private key to indicate that the Registry key or value so marked is to be considered “deleted” and therefore should no longer be visible via the logical merge key view. Hence, in embodiments of the invention, storage for the delete markers is provided and delete markers are created and honored during Registry key or value access operations. Storing the delete markers requires some sort of persistent storage for the delete information. Hence, deletion data may indicate the name of the Registry key or value, location or sub-location deleted and the location from which the Registry key or value, location or sub-location is deleted. These objectives may be realized by storing a special Registry key or value which identifies the deleted Registry key or value, storing another Registry marker such as a re-parse point for the deleted Registry key or value, storing the data in an external (separate) store.

In some WINDOWS operating systems the Registry is transactional, meaning that a number of Registry operations can be done together as a group. When all of the operations have been completed, the changes can either be committed or aborted. Hence either all the changes appear, or none appear. Hence, in some embodiments of the invention, if delete markers are created as part of a transaction, the delete markers do not appear until the transaction is committed, and if the transactions are aborted, the delete markers disappear as well.

Creating a delete marker is required when a Registry key or value is deleted from a merge key. Honoring a delete marker is required when a request to open a Registry key or value is received for a Registry key or value previously deleted from a merge location, when a request to enumerate a Registry key or value is received for a Registry key or value previously deleted from a merge location, when a request to create a Registry key or value is received for a Registry key or value previously deleted from a merge location and so on.

In some embodiments of the invention, when a Registry key or value is deleted, a Registry key or value with the same name will never again be exposed from a contributing location other than the private portion of the merge key. In this case, if a Registry key or value from a contributing (public) location with the same name subsequently came into existence, that Registry key or value would not be visible in the merge key. In some embodiments of the invention, a marker is only created if a Registry key or value of the same name as the Registry key or value being deleted exists in the public portion of the merge key. In this case, deleting the private Registry key or value would otherwise result in exposing or unhiding the public Registry key or value of the same name. Should a Registry key or value of the same name subsequently come into existence, that Registry key or value would be visible in the merge key.

### Exemplary Computing Environment

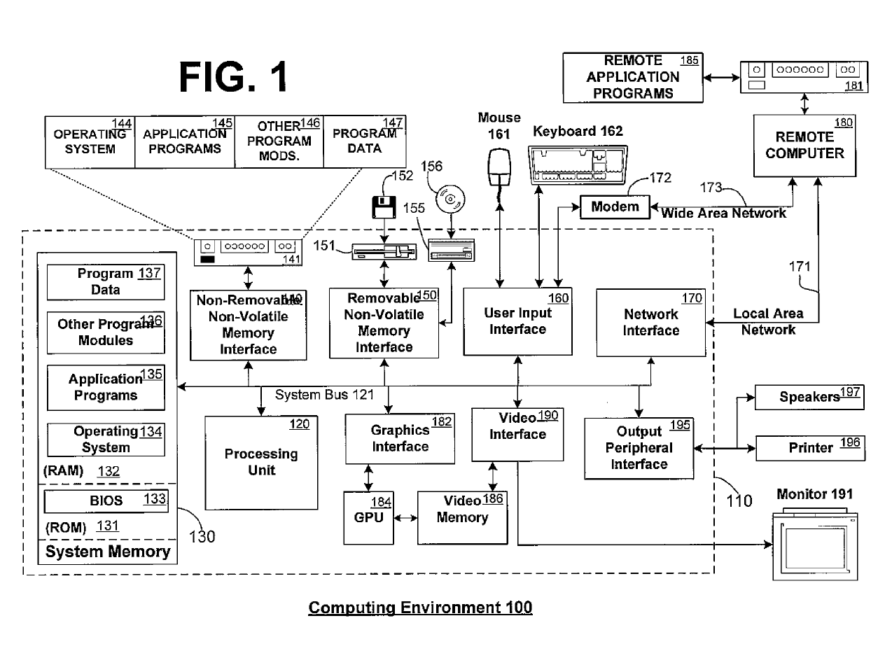

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

### Virtual Deletion in Merged Registry Keys or Values

The operating system monitors Registry access requests (e.g., WINDOWS Registry) made by a process running in a silo. Multiple silos may exist on the computer or in the computer system at the same time. Multiple processes may execute within each silo. A single operating system image creates the silos and creates and monitors all the processes in all the silos. A silo-specific view of a registry key is created by the operating system by an apparent merging of two or more physical backing stores (registry keys) together into what appears to the silo to be a single key. That is, two or more separate registry keys may be exposed to a silo (and the processes running within the silo) as a single key. One or more of the physical backing stores may be used to build a portion of the silo-specific view for one or more of the silos.

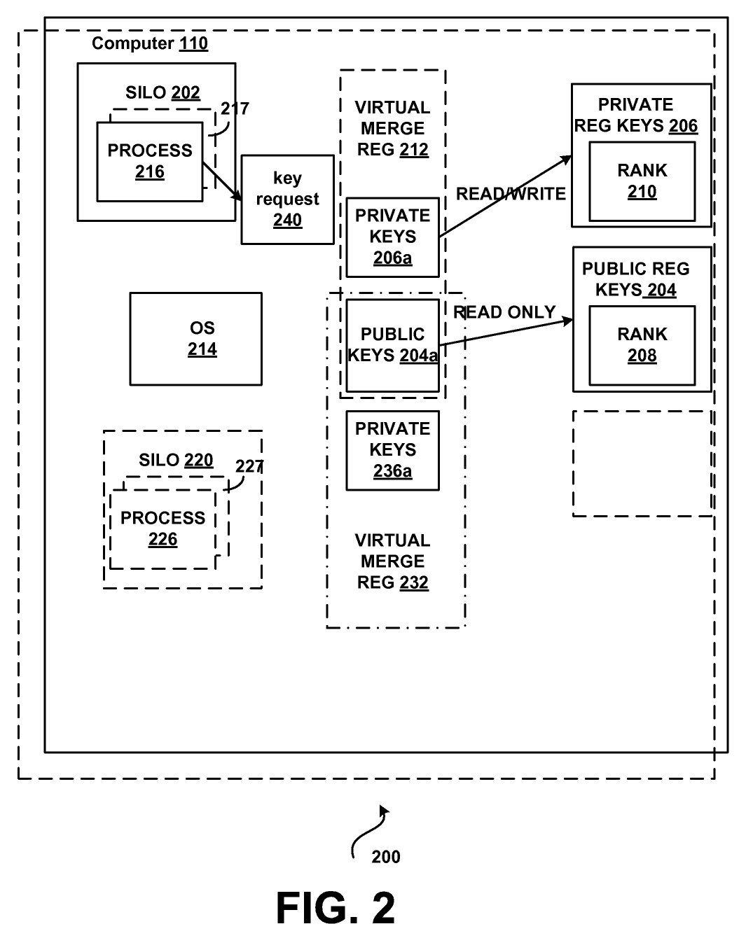

FIG. 2 illustrates one embodiment of a system 200 for virtual deletion of Registry key or values, in a merged Registry as described above. System 200 may reside on one or more computers such as computer 110 described above with respect to FIG. 1. In FIG. 2, one or more execution environments may be running on computer 110. One type of execution environment contemplated is a silo, (described more fully above). In FIG. 2, silo 202 and silo 220 are depicted. Silos may be nested, that is, silo 202 may itself include a silo (not shown). Silos may be nested to any desired level. A silo nested inside another silo is sometimes referred to as a child silo, and the silo in which it is nested is sometimes referred to as its parent silo. A parent silo may control the degree to which its resources (including Registry key or values) are available to its child silos.

A silo may be used to create an isolated execution environment so that resources associated with one silo are available to processes running within that silo but are not accessible to other silos running on the computer or on other computers in the computer system or computer network. For example, if silo 202 were an isolated execution environment a resource (not shown) available to process 216 running in silo 202 would be unavailable to a process such as process 226 running in a second silo, silo 220. A second process running in silo 202 (such as process 217) would however, have access to that resource. Similarly a resource available to processes 226 and 227 would be unavailable to processes 216 and 217 running in silo 202.

Alternatively, in accordance with embodiments of the invention, a silo may be used to create a semi-isolated or controlled execution environment in which some resources are shared and some resources are not shared or in which some portions of a resource are shared and other portions of the resource are not shared. One such contemplated resource is the Registry. For example, in silo 202 one or more processes such as process 216 and 217 may be running and have access to a Registry. In some embodiments of the invention, the Registry is a virtual merged directory of keys 212, wherein the virtual merge Registry 212, although appearing to processes 216 and 217 as a single physical directory is actually a virtual view of the union of two or more sets of Registry keys created by the operating system using callbacks to perform special processing for certain types of operations under certain circumstances. The view created by the operating system 214 may comprise the union of the public keys of the Registry and private or local (to the silo) keys merged together to create the virtual merge Registry. In some embodiments of the invention, duplicate keys are collapsed, with the values of the private keys being used when there is a duplicate key. For example, one of the keys in the public Registry is \registry\machine\software. The key, may, for example, be a location where an application can write machine global state. It is desirable to allow an application running in a silo to write its own state in its own copy of \registry\machine\software (i.e., \registry\machine\silo000software) but to enable the silo to share the state in the public version of \registry\machine\software. In this way the silo is able to see any changes made in the external system but can make its own changes or write new keys which will only exist in its private location and thus will not affect the system external to the silo. Hence the Registry keys \registry\machine\software and registry\machine\silo0000software are merged. The silo will see a key called \registry\machine\software but its contents will be the combination of the physical \registry\machine\software and registry\machine\silo0000software. Thus the merge Registry created by the operating system in some embodiments of the invention includes the value of the global keys while a private, unshared portion of the key is associated with a particular silo (e.g. with silo 202), and may represent, for example, local or private keys for applications running in that silo. For example, in FIG. 2, a virtual merge key 212 associated with silo 202 includes a shareable portion 204a derived from the value of the global key 204 and an unshareable (private) portion 206a derived from the value of a local key (e.g., a private, unshared key 206 associated with silo 202). A virtual merge Registry 232 associated with silo 220 includes a shareable portion 204a derived from the value of a global key 204 and an unshareable portion 236a derived from the value of a local key (e.g. a private, unshared key 203 associated with silo 220). In some embodiments of the invention, the shareable portion 204a of the key 212 is read-only while the private, unshared portion 206a of the key 212 is read-write, although it will be appreciated that the contemplated invention is not so limited. That is, the private portion of the virtual merge Registry keys may be read-only or read-write or may include portions which are read-only or read-write. Similarly, the shareable portion of the virtual merge Registry keys may be read-only or read-write or may include portions which are only read-only or read-write. Moreover, it will be appreciated that the invention as contemplated is not limited to merging two values or two sets of keys. Any number of keys (n keys) may be merged to create the virtual merge Registry. The virtual merge Registry in some embodiments of the invention is not persisted on permanent storage or created per se in memory but is dynamically deduced by the operating system 214 as required, by monitoring Registry key access requests and performing special processing associated with the type of access request as described more fully below.

Thus, it will be appreciated that as more than one silo may exist on a computer or in a computer system at one time, more than one view of the Registry may also exist at one time, that is, there is a one-to-one correspondence between silo and virtual merge Registry but any number of silos and merge views may exist at any one time on a particular computer or computer system. Moreover, a portion of each key in the virtual merge Registry may include a shareable portion which may or may not be the same for all silos in the computer system and may or may not be identical to physical backing Registry 204. In some embodiments of the invention, all of the applications or processes running within all the silos in the system share a single shareable portion of the silo's merge Registry which may or may not exist on the particular computer on which the silo is running. Moreover, the physical directory which “backs” a shareable or unshareable portion of the merge Registry may exist on removable media, such as a removable disk, CD ROM, USB key, etc. Similarly, the physical backing Registry may reside on a remote system. The same is true for the private or unshareable portion of the keys of the merge Registry and its backing store.

In some embodiments of the invention, the mechanism in the operating system 214 which creates the merged view of the Registry (e.g., merged keys 212 and 232) is a filter driver which is able to insert itself into the code paths of operations by registering callbacks. In some embodiments of the invention, the callbacks registered for include RegNtPreCreateKeyEx(Ex), RegNtPostCreateKeyEx(Ex), RegNtPreQueryKey, RegNtPreEnumerateKey, RegNtPreEnumerateValueKey, RegNtPreRenameKey and RegNtPreKeyHandleClose, although it will be appreciated that other callbacks may be registered. In some embodiments of the invention, the operations for which special processing (e.g., via callbacks) is performed are enumeration, open, create, rename and close operations for Registry keys. For example, an enumeration operation may be associated with RegNtPreEnumerateKey and RegNtPreEnumerateValueKey callbacks, open and create with RegNtPreCreateKeyEx(Ex), RegNtPostCreateKeyEx(Ex), close with a RegNtPreKeyHandleClose callback and rename with a RegNtPreRenameKey callback. In some embodiments, when a Registry key access request is sent from a process, the operating system monitors the request via the callbacks and if the operation is one of those for which special processing is to occur, performs the special processing. For example, in FIG. 2 operating system 214 may monitor Registry key access requests such as request 240 initiated by process 216 in silo 202 and perform special processing to create virtual merge Registry 212 from private keys 206 (associated with silo 202) and public keys 204. The portions of the keys in virtual merge Registry 212 deriving from private keys 206 are represented by (virtual) private keys 206a and the portions of virtual merge Registry 212 deriving from public keys 204 are represented by (virtual) public keys 204a.

Each of the contributing (backing store) keys may be associated with a rank, (e.g, in FIG. 2 private (backing store) keys 206 are associated with rank 210, public keys (backing store) 204 are associated with rank 208). Rank in some embodiments is used as a tie breaker when required. For example, if a key access (e.g., open, enumerate, etc.) is requested, and the indicated value exists in two sets of keys under the same name, the rank of the contributing set may be used to determine which value is exposed to the requester, that is, the value of the key in the set of keys having the highest rank is exposed to the requestor (as for example, the writable portion of the key). Similarly, if a given name is a key in one contributing directory and the same name is a sub-directory in another contributing set of keys, the entry in the set having the highest rank is exposed to the requestor in some embodiments.

For example, a Registry key enumeration in some embodiments is the union of all the keys from all the contributing sets of keys. If the same name exists in more than one of the contributing sets, the rank of each of the contributing sets is used to determine which set's version of the value should be exposed. When creating a key, if the key does not already exist in any of the contributing sets it will be created in the set with the highest rank. When renaming a key, each of the contributing sets of keys is queried to determine that the new name is not already in use, and if it is not, then the key will be renamed to the new name.

When a need for virtual deletion of a Registry key or value becomes necessary or desirable, in some embodiments of the invention, a Registry key or value (located in the private portion of the merge key) is marked with a delete marker instead of being actually deleted. From the silo's point of view, a Registry key or value so marked is deleted.

To address the above need, delete markers are associated with a Registry key or value for which a delete request has been received in the merge key environment. When a merge key is exposed, typically there will be a private portion of the merge key which is writable and a public portion (made up of one or more public locations) which are read-only. Both the private location and the public location or directories contribute to the logical merge key. New Registry key or values and potentially modifiable Registry key or values (via copy-on-write operations) typically go into the private portion of the merge key. The Registry key or values in the public portion of the merge key are typically visible but are not modifiable. A Registry key or value created in the private location with the same name as a Registry key or value or Registry key or values in a contributing public location or directories will typically mask or hide the public Registry key or values because a private Registry key or value outranks a similarly-named public Registry key or value. But if the private highest-ranking Registry key or value is deleted, one of the public Registry key or values may be unhidden or exposed, because now the public Registry key or value is the highest ranking Registry key or value of that name. To an application that previously accessed the private Registry key or value, the private Registry key or value will not appear to have been deleted. An application that had previously accessed the private Registry key or value may now access the previously hidden but now exposed Registry key or value instead, which to the application's knowledge, is the same Registry key or value, although the content of the previously hidden Registry key or value may well be different. Furthermore, further attempts to delete the Registry key or value will fail because the Registry key or value now being opened is in a read-only location. This is problematic. To address these problems, a marker is added to the private location to indicate that the Registry key or value marked is to be considered “deleted” and therefore should no longer be visible via the logical merge key view. Hence, in embodiments of the invention, storage for the delete markers is provided and delete markers are created and honored during Registry key or value access operations. Storing the delete markers requires some type of persistent storage for the delete information. A number of options for storing delete markers are contemplated. One option is to decorate the name of the deleted Registry key or value to indicate deletion. For example, if the registry value “ABC” were deleted, a new value with the name “$$deleted$$:ABC” may be written to the Registry directory in the private location. That is, a deletion marker may be created by creating a new key or value with a decorated name derived from a name of the key or value being deleted and may be written to the private portion of the Registry. Presence of the appropriate decoration or message indicates a virtually deleted Registry key or value. It will be apparent that any type of decoration or message may indicate a virtual deletion: the decoration shown is merely an example of one possible decoration. Another option is storing the delete marker as a reparse point. Another option is storing the delete marker in an external database. For example, a delete marker such as the name of the Registry key or value, a decorated name or reparse point could be stored in another location in the Registry key or value system (perhaps in a Registry key or value, location, or sub-location called “Deleted Registry key or values”) or delete markers could be stored in another non-Registry key or value system store. In this case, instead of storing a decorated name to indicate a virtually deleted Registry key or value, the name of the deleted Registry key or value would be stored, requiring a lookup operation to determine if a given Registry key or value was virtually deleted. Hence, deletion data may indicate the name of the Registry key or value deleted and the location from which the Registry key or value is deleted. These objectives may be realized by storing a delete marker which identifies the deleted Registry key or value, storing another Registry key or value marker such as a re-parse point for the deleted Registry key or value, or storing the delete data in an external (separate) store. Because a deletion may occur within a transaction, any implementation used should be transaction-aware. Storing the data in an external store requires that the external store can participate in a transaction, meaning that the external store would know when a transaction is being committed, and would commit the results during the commit. Similarly, if the transaction were aborted, the external store would roll back (or undo) changes. It would also have to provide a view within a transaction that the action had already occurred, but outside the transaction make it look like the action had not yet occurred.

Creating a delete marker is required when a Registry key or value is deleted from a merge key. Honoring a delete marker is required when a request to open a Registry key or value is received for a Registry key or value previously deleted from a merge location, when a request to enumerate a Registry key or value is received for a Registry key or value previously deleted from a merge location, when a request to create a Registry key or value is received for a Registry key or value previously deleted from a merge location and so on.

In some embodiments of the invention, when a Registry key or value is deleted, a Registry key or value with the same name will never again be exposed from a contributing location other than the private portion of the merge key. In this case, if a Registry key or value from a contributing (public) location with the same name subsequently came into existence, that Registry key or value would not be visible in the merge key. In some embodiments of the invention, a marker is only created if a Registry key or value of the same name as the Registry key or value being deleted exists in the public portion of the merge key. In this case, deleting the private Registry key or value would otherwise result in exposing or unhiding the public Registry key or value of the same name. Should a Registry key or value of the same name subsequently come into existence, that Registry key or value would be visible in the merge key.

In some embodiments of the invention, the filter driver of the operating system hooks various Registry key or value access operations and in cooperation with the merge key operations described above, exposes the correct semantics for the virtually deleted Registry key or values. For example, with respect to an operation such as an enumeration operation deletion markers themselves are hidden and any Registry key or values which have been virtually deleted are hidden. That is, delete markers may be filtered out so that the delete markers are not returned when an enumeration request is received. Similarly, Registry key or values for which a delete marker exists are not returned in response to the enumeration request. For an operation such as create or open a caller is prevented from opening a delete marker or a virtually deleted Registry key or value. In a merge key environment, logic is provided when an open or create operation request is received to determine whether to try to open the Registry key or value, in the private or public portion of the merge key. If the Registry key or value specified in the open is in the public portion, a check is performed to determine if a delete marker for that Registry key or value exists in the private location. If it does, the open fails (for example returning “status object name not found”). A Registry key or value that has the form of a delete marker is not allowed to be opened. For a rename operation, renaming a Registry key or value to a name in the form of a delete marker is not permitted. For a delete operation, a delete marker is created for the Registry key or value in the private portion of the merge key. Delete markers in some embodiments of the invention are created by creating a new Registry key or value with a decorated version of the Registry key or value name. A decorated version of a key or value name uses the original key or name to be deleted as a base and adds to it a prefix or suffix or both to create a decorated version. The presence of the decorated Registry key or value indicates that the key or value has been virtually deleted. Traditionally, before a key can be deleted, the key must be empty. In the case of a key virtual deletion, in some embodiments of the invention, a delete marker for the key is created, the nested delete markers are deleted and then normal delete processing if appropriate is performed. (For example, the delete may occur if the key was open from the private location.) A key may also be queried. The result of the query may include information such as the number of sub-keys and values. In some embodiments the query operations are filtered to update the subkey/value counts and the max subkey length and max value name length fields.

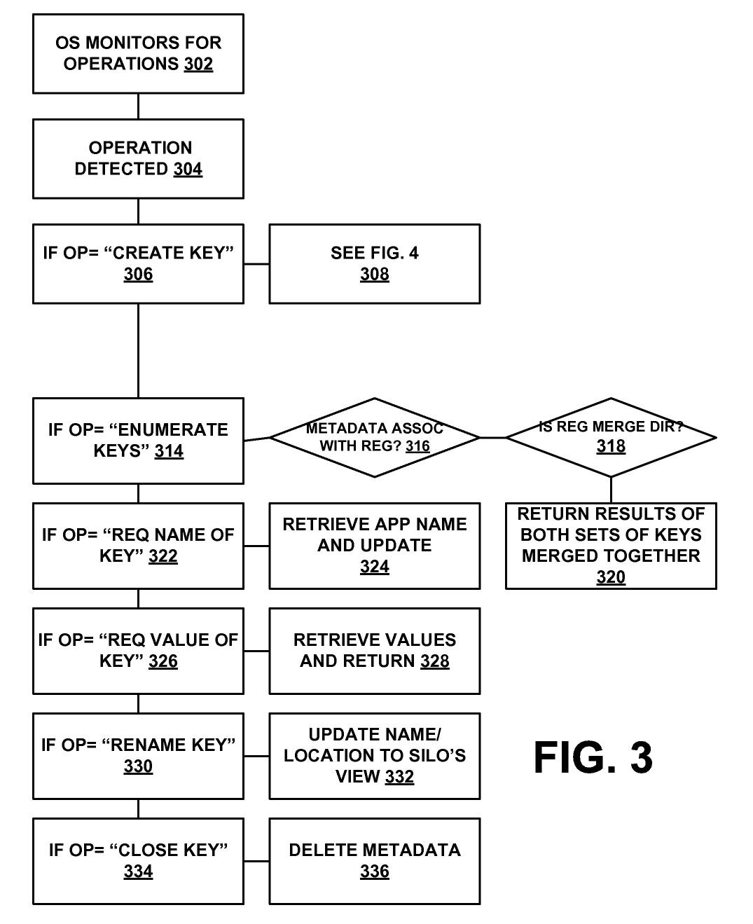

FIG. 3 is a flow diagram of a method for merging keys in accordance with embodiments of the invention. At 302 the operating system (e.g., OS 214 of FIG. 2) monitors Registry key access requests (such as access request 240 made by process 216 running in silo 202). When a key access request is detected by the operating system (304) (e.g., via callbacks), the operating system 214 determines the type of access request made (306, 314, 322, 326, 330 and 334) and performs the appropriate processing as described more fully below.

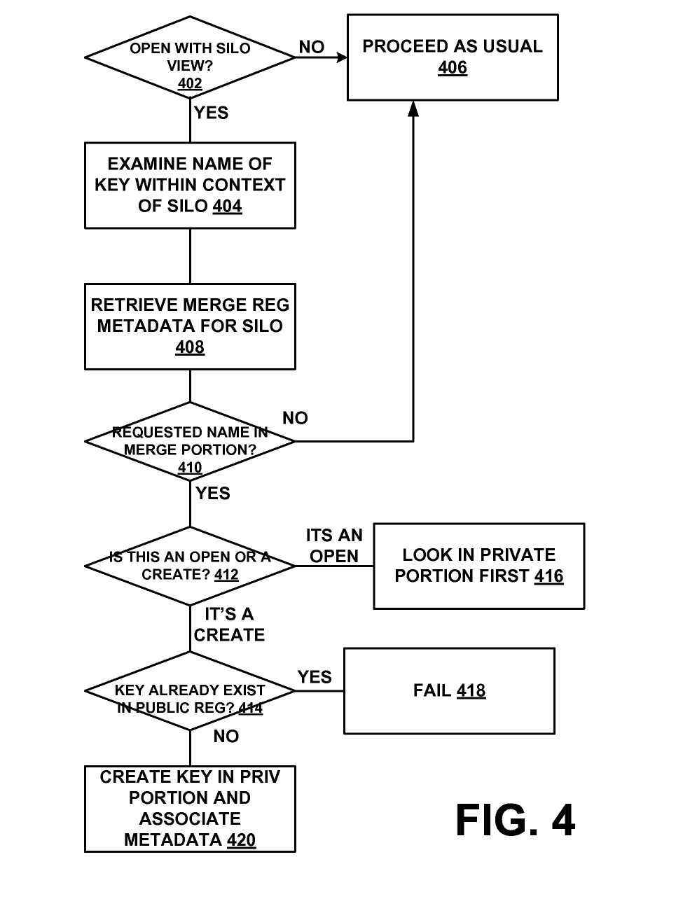

For example, at 306, the operating system may determine that the key access request is an operation that opens or creates a key (306). FIG. 4 is a flow diagram of the processing (308) that may then occur. When an open or create request is sent to a volume on which a merge Registry exists, a create callback (e.g., RegNtPreCreateKeyEx (Ex)) is invoked which enables a filter driver of the operating system to examine the request to determine if special processing is required. When an open or create operation is invoked, an absolute path name or a path name relative to an existing open key is provided. When a relative open is used, name parsing begins at the registry node referenced by the relative handle. In the case of an absolute open, the IO Manager of the operating system parses the name, the object manager resolves a portion of the name that leads to a device object and passes the unresolved balance of the name (the portion that has not yet been resolved) back to the I/O Manager, along with a pointer to the device object it located. Special processing is required when the portion of the key referred to is the silo view (402) instead of the global portion. As used herein, performing an operation “using the silo view” means that the name of the key is interpreted within the context of the silo's virtual merged Registry instead of within the the normal physical view of the registry.

At 402, if the open is an absolute open (not a relative open) and the caller is in a silo processing continues at 404. In some embodiments of the invention, the operating system determines if the open or create key is a relative or an absolute open/create by looking at several fields in the access request. If the access request includes only a key name, and the thread originating the request does not belong to a process running in a silo, the request is considered to be an absolute open. The information stored in the request can be used to retrieve metadata associated with the key (408).

Thus, at 404, the name of the key being accessed is examined within the context of the silo. A new key object is created using the silo view whenever the key referenced in the request was originally opened within a silo. Because all access requests to the key object are filtered, two or more backing objects may be accessed to provide the silo view. The key is also opened using the silo view whenever a relative open instead of an absolute open is used. In some embodiments of the invention, if a field in the request representing an existing open key is not null, the request is considered to be a relative request. If, at 402, the caller is not in a silo or if the original key was not opened in a silo, then processing proceeds as normal (406). If the request uses an absolute name (that is, names the key is explicitly referenced using a path name and the open key field of the request is null), the operating system determines if the process initiating the request (the caller) is in a silo or not. In some embodiments of the invention, the operating system determines if the caller is in a silo by determining if the thread originating the access request is in a silo. Alternatively, in some embodiments the operating system may determine if the caller is in a silo by examining the access request which may be tagged with a silo identifier if the request originated from a caller in a silo. If the caller is in a silo, the key is opened using the silo view and the private value is returned.

Thus, if the key referenced in the request was not originally opened in a silo, or if the request is an absolute open and the caller is not in a silo, processing continues at 406. At 404, if the operation is to be processed using the silo view, the name of the key in the request is examined and is interpreted within the context of the silo. In some embodiments of the invention, a silo is provided a view of the registry having the same hierarchy as the underlying machine (that is, the silo's view appears to have the same hierarchy as the infrastructure or “system silo”). For example, if \registry\machine\software exists in the infrastructure, \registry\machine\software is exposed within the silo. This may be done so that applications which expect this hierarchy will find it. However, the keys that back the hierarchy may be changed so that \registry\machine\software within the silo is actually a merge of the physical \registry\machine\software and \registry\machine\silo000software (the silo-specific registry). Normal error processing occurs. That is, if, for example, in an open operation, the key identified by the name in the access request is searched for but is not found in any of the target keys, an error message is returned. If a sub-key is found in an appropriate key, an open key is returned to the caller. Metadata may be attached before it is returned to the caller for a successful open or create. If the key is not found, the key is created or an error message is returned. At 408 the merge Registry key metadata for the silo is retrieved. At 410 if the requested name is not found in the merge Registry, processing proceeds as normal (406). For example, an error message may be returned stating that the key is not found. At 410, if the requested name is found in the merge Registry view, information is returned so that it can be determined whether the named key is to be created or opened (412). In some operating systems the “create operation” can be used both to open and to create keys. If the requested operation is an “open key” at 416, (i.e., the request is attempting to access an existing key) the operating system checks the private contributing key first by determining if the key exists in the private (unshareable portion) of the merge Registry. At 416 if the operating system determines that the key does not exist in the private portion of the virtual merge Registry, the public portion of the merge Registry is examined. If the key does not exist in the public portion of the merge Registry, an error message is returned. If the key is found in the merge Registry, the open key is returned. If at 412 it is determined that the key is to be created, (i.e., the request is a create key request) at 414, the operating system checks the public location to make sure that the key does not already exist in the public portion of the merge Registry. If it does, an error results (418). If it does not, the key is created in the private portion of the merge Registry, metadata is associated with the key and the created key is returned to the caller, along with the metadata (420).

In some embodiments of the invention, the metadata will be attached to the open key during RegNtPrePostCreate.

Referring again to FIG. 3, there are several different types of enumeration requests. If the operating system detects an enumeration request for the children of a key a list of keys are returned. At 314, if the operating system detects an enumerate key operation at 314, first, the operating system determines if there is metadata associated with the key (316). In some embodiments of the invention, (318) the operating system determines whether the Registry is merge view from the metadata. In either case, if the Registry is a merge view (318) the results of both keys merged together is returned (320). If the Registry is not a merge view, normal processing is performed. If the operation is a request for the value of a key (326), the values of the keys are returned (328). Global and private values for the key are merged.

If the operation is a query (322) (such as a request for the name or other information about the key) the physical name of the key is retrieved at 324 and the name is updated, if necessary, to reflect the proper name for the requester. In some instances, if a request for the name of a key is received or a request for other information about a key is received, the silo relative name rather than the global name of the key is returned.

If the operation encountered is a rename key (330) the operating system must ensure that the new name (the name to which the key is going to be renamed), which is a silo-relative name is translated into a global name before the underlying registry sees it so that the registry renames the key properly. If at 334 the operation is determined to be a close, the RegNtPreKeyHandleClose callback is invoked. At 336 any metadata associated with the key being closed is deleted. It will be appreciated that one or more of the above listed actions may be optional or skipped and that the actions may proceed in a sequence other than that depicted in FIG. 3.

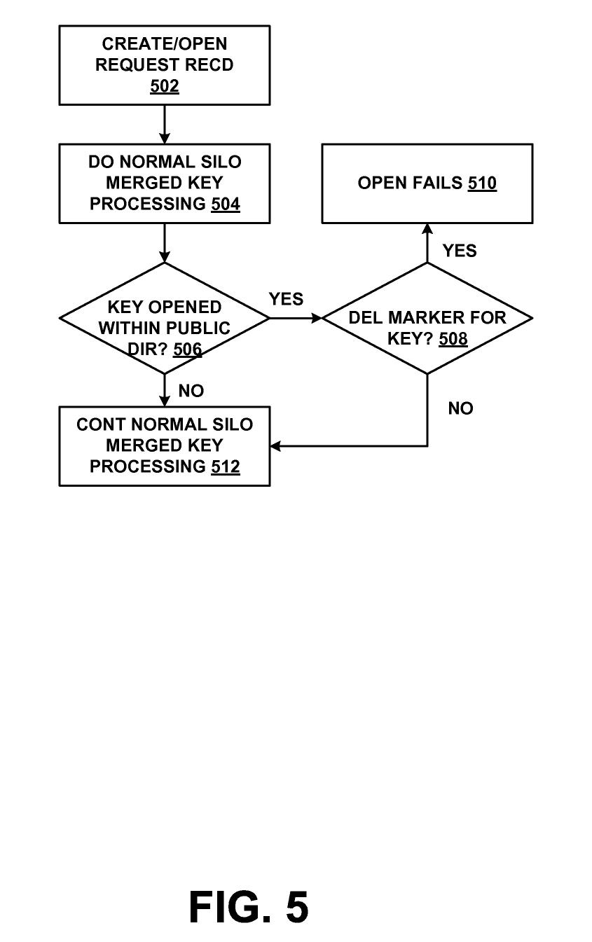

FIG. 5 illustrates some embodiments of an create/open operation honoring a virtual deletion. At 502 a create/open request for a Registry key or value. At 504 normal silo merge key processing is performed as described above. At 506 it is determined if the Registry key or value being opened is within a public contributing location or not. At 508, if the Registry key or value being opened is located within the public portion of the merge key, it is determined if there is a deletion marker for the Registry key or value in question and if so at 510 the open request fails. If at 508 it is determined that there is no delete marker for the Registry key or value in question, normal silo merge key processing is performed (512). If at 506 it is determined that the Registry key or value, location or sub-location being opened is not within a public contributing location processing continues at 512. A delete marker may be implemented in any suitable fashion, as described above.

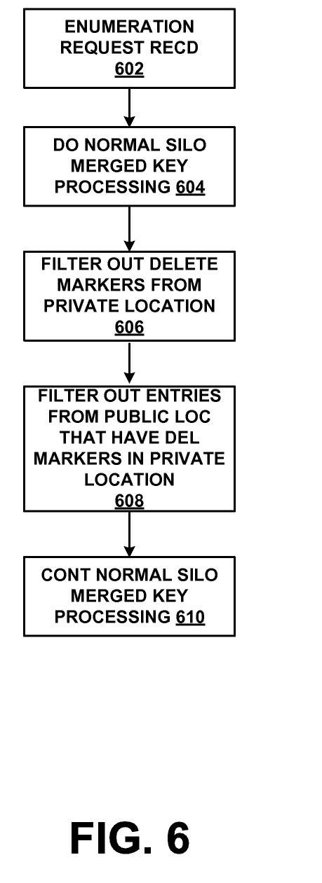

FIG. 6 illustrates some embodiments of an Registry key enumeration operation honoring a virtual deletion. At 602 an enumeration request for a Registry key or value, location or sub-location is received. At 604 normal silo merge key processing is performed as described above. At 606 deletion markers are filtered from the private location (private portion of the merge key). At 608, entries in the public location which have corresponding delete markers in the private location are filtered out. At 610 normal silo merge key processing is performed. In some embodiments of the invention, Registry key or values for which a deletion marker exists are filtered out. The results are displayed or otherwise returned.

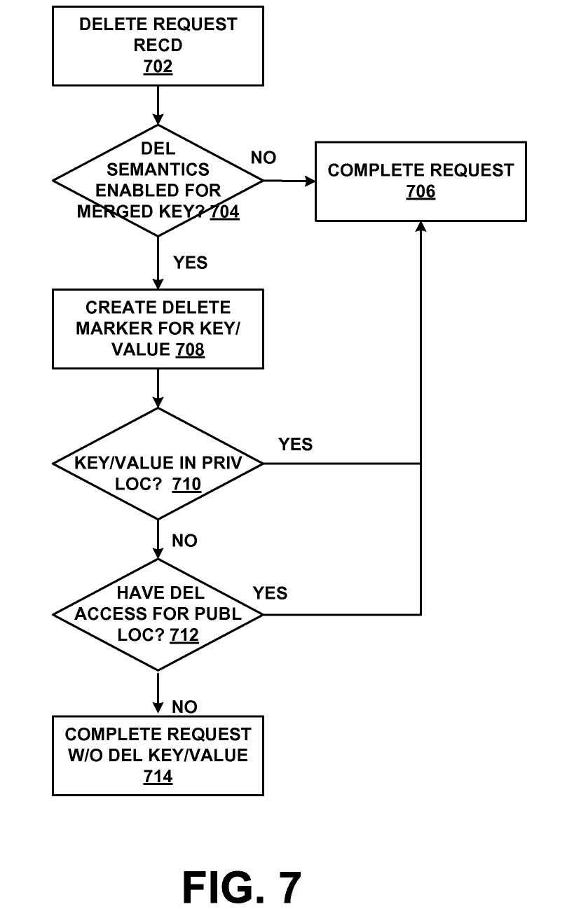

FIG. 7 illustrates some embodiments of a virtual deletion operation. At 702 a delete request for a Registry key or value is received. At 704 if virtual deletion semantics are not enabled for the merge key, normal processing continues at 706. If, however, virtual deletion semantics are enabled for the merge key, processing continues at 708 and a deletion marker is created for the Registry key or value being deleted. At 710 if the Registry key or value for which the deletion request is received is in a private location, the Registry key or value is “deleted” (706). At 710 if the Registry key or value for which the deletion request is in a public location, processing continues at 712. At 712, if the access permissions associated with the delete request allow it, the Registry key or value is “deleted” (706). At 712 if the access permissions associated with the delete request do not allow it, the Registry key or value is not deleted (714).

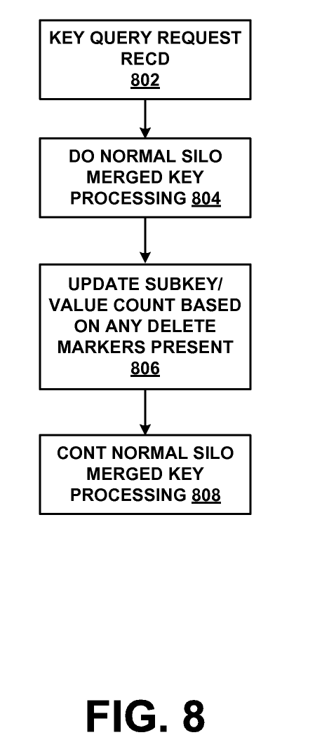

FIG. 8 illustrates some embodiments of a query key operation. At 802 a query request for a Registry key is received. At 804 normal silo query key processing is performed. At 806 the subkey/value count based on any delete markers present is updated. At 808 normal silo merge key processing is performed.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A system for performing a virtual deletion of a Registry element in merged Registry keys comprising:
an operating system that provides a silo-specific merged view of a plurality of sets of Registry keys or values for processes running in a silo, wherein the operating system creates the silo-specific merged view by monitoring Registry key or value access requests initiating from the processes running in the silo and in response to detecting a Registry key or value deletion request, performs callback processing that creates a deletion marker for an element identified in the Registry key or value deletion request, wherein the element for which the deletion marker has been created is filtered from the silo-specific merged view of the plurality of sets of Registry keys or values that appears to the processes running in the silo to be a single Registry comprising entries in the plurality of sets of Registry keys or values.

2. The system of claim 1, wherein each of the plurality of sets of Registry keys or values system directories is associated with a rank.

3. The system of claim 2, wherein the rank associated with each of the plurality of sets Registry keys or values is used as a tiebreaker to determine entries included in the silo-specific view when more than one entry in the plurality of sets is known by a particular name.

4. The system of claim 3, wherein the silo-specific merged view comprises a private location and at least one public location, wherein virtual deletion of the element identified in the deletion request in the private location hides a same-named element in the at least one public location.

5. The system of claim 1, wherein the operating system includes a filter driver that detects virtual deletions via callbacks inserted in Registry key or value access request processing paths comprising delete processing, enumeration processing, create processing, open processing, query processing or rename processing.

6. The system of claim 5, wherein the Registry key or value deletion request creates a deletion marker for the Registry key or value identified in the Registry key or value deletion request.

7. A method for providing a view of a plurality of sets of Registry keys or values comprising a view of a virtual merge key comprising a plurality of Registry keys or values to processes running in a silo comprising:
monitoring access requests made by a process running in the silo using a filter driver in an operating system, wherein the filter driver detects virtual deletion of a key or value of a merged virtual Registry by presence of a deletion marker associated with the key or value;
in response to detecting the deletion marker, performing processing associated with a type of Registry key or value access request wherein the element associated with the deletion marker is filtered from the view of the plurality of sets of Registry keys or values.

8. The method of claim 7, further comprising creating the deletion marker by creating a new key or value with a decorated name derived from a name of the key or value being deleted identified in the deletion request.

9. The method of claim 7, further comprising storing the deletion marker in an external data store.

10. The method of claim 7, wherein in response to determining that the Registry key or value access request is an enumerate Registry key or enumerate value operation, the operating system returns the view wherein the view comprises a list of entries in the first Registry key or value location and the second Registry key or value location except for entries associated with deletion markers.

11. The method of claim 7, wherein in response to determining that the Registry key or value access request is an enumerate Registry key or enumerate value operation, the operating system returns the view wherein the view comprises a list of entries in the first Registry location and the second Registry location except for entries comprising deletion markers.

12. The method of claim 7, wherein a Registry key or value access request that renames a Registry key or value system element to a name indicating virtual deletion is prohibited.

13. The method of claim 7, wherein a Registry key or value access request that attempts to open an element associated with a deletion marker fails.

13. The method of claim 7, wherein access of the process to entries in the first Registry key location is restricted to read-only access via creation of the view.

14. The method of claim 7, wherein a set of access privileges for the process to entries in the second Registry key location permits deletion of the entries.

15. A computer-readable medium having program code stored thereon that, when executed by a computing environment, causes the computing environment to:
use a filter driver of an operating system to monitor processes running in a silo, wherein the filter driver detects a Registry access request made by a process running in the silo;
in response to detecting the Registry access request, perform processing associated with a type of Registry key or value access request wherein a view of a plurality of sets of physical Registry keys or values is provided to the process, wherein the view presents the plurality of sets of physical Registry keys or values to the process as a single merged virtual Registry comprising entries of the plurality of sets of physical Registry keys or values, wherein entries associated with deletion markers are eliminated from the view.

16. The computer-readable medium of claim 15, having further program code stored thereon, that when executed by the computing environment, causes the computing environment to:
create a deletion marker for an element identified by a delete access request, wherein the deletion marker comprises a decorated key or value name derived from a name of the element being deleted identified in the deletion request.

17. The computer-readable medium of claim 15, having further program code stored thereon, that when executed by the computing environment, causes the computing environment to:
associate a deletion marker with an element identified by a delete access request, wherein the deletion marker is stored in an external datastore.

18. The computer-readable medium of claim 15, having further program code stored thereon, that when executed by the computing environment, causes the computing environment to:
associate a deletion marker with an element identified by a delete access request, wherein the deletion marker is stored in the Registry.

19. The computer-readable medium of claim 16, having further program code stored thereon, that when executed by the computing environment, causes the computing environment to:
filter out elements associated with deletion markers when an enumerate request is received.

20. The computer-readable medium of claim 16, having further program code stored thereon, that when executed by the computing environment, causes the computing environment to:
prohibit creating a name for a new Registry entry, wherein the name comprises a deletion marker.
